(19) United States
(12) Patent Application Publication
(10) Pub. No.: US 2015/0207800 A1
(43) Pub. Date: Jul. 23, 2015

(54) SYSTEMS AND METHODS FOR ENABLING ACCESS TO A WEB APPLICATION

(71) Applicants: John Nicholas Jitkoff, Palo Alto, CA (US); Erik Kay, Belmont, CA (US)

(72) Inventors: John Nicholas Jitkoff, Palo Alto, CA (US); Erik Kay, Belmont, CA (US)

(73) Assignee: Google Inc, Mountain View, CA (US)

(21) Appl. No.: 13/481,660

(22) Filed: May 25, 2012

Related U.S. Application Data
(63) Continuation-in-part of application No. 13/110,776, filed on May 18, 2011.
(60) Provisional application No. 61/345,999, filed on May 18, 2010.
(60) Provisional application No. 61/346,000, filed on May 18, 2010.
(60) Provisional application No. 61/346,013, filed on May 18, 2010.

(51) Int. Cl. H04L 29/06; H04L 29/08

(52) U.S. Cl. CPC H04L 63/102; H04L 67/02

(57) ABSTRACT

Systems and methods for enabling access to a web application are provided. In some aspects, a method includes determining a first profile to be used for accessing the web application, generating a first access point based on the first profile, enabling automatic access to the web application under the first profile via the first access point, and determining a second profile to be used for accessing the web application. The second profile is different from the first profile. The method also includes generating a second access point based on the second profile, and enabling automatic access to the web application under the second profile via the second access point.

### CROSS-REFERENCES TO RELATED APPLICATIONS

This application is a continuation-in-part of U.S. patent application Ser. No. 13/110,776 (titled “Browser Interface for Installed Applications” and filed on May 18, 2011), which claims the benefit, under 35 U.S.C. §119, of U.S. Provisional Patent Application No. 61/345,999 (titled “Installable Web Applications” and filed on May 18, 2010), U.S. Provisional Patent Application No. 61/346,000 (titled “Web Store for Digital Goods” and filed on May 18, 2010), and U.S. Provisional Patent Application No. 61/346,013 (titled “Chrome Extensions” and filed on May 18, 2010). The disclosures of the foregoing patent applications are incorporated by reference herein in their entirety for all purposes.

### FIELD

The subject technology generally relates to web applications and, in particular, relates to systems and methods for enabling access to web applications.

### BACKGROUND

Browsers typically enable users to interact with and experience many different types of content, usually over a computer network, and often in a visual or graphical manner. For example, users may install one or more internet browsers on a local computing device, and may thereafter utilize the internet browser to access content and/or functionality provided by a remote computing device.

### SUMMARY

According to one general aspect, a computer-implemented method includes providing a user interface in a browser application, displaying on the user interface one or more applications installed in the browser application and enabling interaction with the installed applications through the user interface in the browser application.

In another general aspect, a computer-readable storage medium has recorded and stored thereon instructions that, when executed by a processor, cause the processor to perform a method, where the method includes providing a user interface in a browser application, displaying on the user interface one or more applications installed in the browser application and enabling interaction with the installed applications through the user interface in the browser application.

In another general aspect, an apparatus includes instructions stored on a computer-readable storage medium that are executable by at least one processor to execute a browser application and thereby provide a browser interface, where the apparatus includes a user interface configured to display one or more applications installed in the browser application and a management module configured to cause the at least one processor to enable interaction with the installed applications through the user interface in the browser application.

Implementations for each of the general aspects may include one or more of the following features. For example, control of one or more features of the installed applications may be enabled through the user interface in the browser application. Selection of a launch mode for each of the installed applications may be enabled through the user interface in the browser application. An option to uninstall each of the installed applications may be enabled through the user interface in the browser application. Control of declared permissions for each of the installed applications may be enabled through the user interface in the browser application. A search mechanism to search for installed applications may be provided through the user interface in the browser application. A review mechanism to enable submission of a review for each of the installed applications may be provided through the user interface in the browser application.

According to various aspects of the subject technology, a computer-implemented method for enabling access to a web application is provided. The method comprises determining a first profile to be used for accessing the web application, generating a first access point based on the first profile, enabling automatic access to the web application under the first profile via the first access point, and determining a second profile to be used for accessing the web application. The second profile is different from the first profile. The method also comprises generating a second access point based on the second profile, and enabling automatic access to the web application under the second profile via the second access point.

According to various aspects of the subject technology, a system for enabling access to a web application is provided. The system comprises a management module configured to determine a first profile to be used for accessing the web application, to generate a first access point based on the first profile, to enable automatic access to the web application under the first profile via the first access point, and to determine a second profile to be used for accessing the web application. The second profile is different from the first profile. The management module is further configured to generate a second access point based on the second profile, and to enable automatic access to the web application under the second profile via the second access point.

According to various aspects of the subject technology, a computer-readable medium encoded with executable instructions for enabling access to a web application is provided. The instructions comprise code for determining a first profile to be used for accessing the web application, generating a first access point based on the first profile, enabling automatic access to the web application under the first profile via the first access point, and determining a second profile to be used for accessing the web application. The second profile is different from the first profile. The instructions also comprise code for generating a second access point based on the second profile. The second access point is visually different from the first access point. The instructions also comprise code for enabling automatic access to the web application under the second profile via the second access point. The automatic access to the web application under the first profile and the automatic access to the web application under the second profile are enabled at the same time.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is an example of a screen shot of a web page in a browser application.

FIG. 2 is an example of a screen shot of a web page and an application management window in a browser application.

FIG. 3 is an example of a screen shot of a web page and an application shortcut window in a browser application.

FIG. 4 is an example of a screen shot of a web page and an application permissions window in a browser application.

FIG. 5 is an example of a screen shot of a web page and a search field in a browser application.

FIG. 6 is an example of a screen shot of a web page and a review field in a browser application.

FIG. 7 is an example of a block diagram of a system.

FIG. 8 is a flowchart illustrating example operations of the system of FIG. 7.

FIG. 9 is a block diagram showing example or representative computing devices and associated elements that may be used to implement the systems and methods described herein.

FIG. 10 illustrates an example of a method for enabling access to a web application.

FIGS. 11A and 11B illustrate examples of access points that may be used to access a web application.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

In some aspects, this document relates to systems and techniques for a user interface surface integrated as part of a browser application for interacting with and managing applications installed in the browser application. The user interface provides an interactive interface to organize and launch the installed applications. The user interface also provides an interactive interface to manage functionality of the installed applications including, for example, launch modes, permissions, integration with the operating system, rating and reviewing an installed application and uninstalling an installed application. The user interface also provides a search interface to find and launch installed applications using a search query. In this manner, a single user interface integrated in the browser application provides multiple control and management features related to the applications installed in the browser application.

Throughout this document, the terms browser and browser application may be used interchangeably to mean the same thing. In some aspects, the terms web application and web app may be used interchangeably to refer to an application, including metadata, that is installed in a browser application. In some aspects, the terms web application and web app may be used interchangeably to refer to a website and/or application to which access is provided over a network (e.g., the Internet) under a specific profile (e.g., a website that provides email service to a user under a specific profile). The terms extension application, web extension, web extension application, extension app and extension may be used interchangeably to refer to a bundle of files that are installed in the browser application to add functionality to the browser application. In some aspects, the term application, when used by itself without modifiers, may be used to refer to, but is not limited to, a web application and/or an extension application that is installed or is to be installed in the browser application.

An extension application may be a zipped bundle of files that adds functionality to the browser application. Extension applications may be web pages and may use all of the application programming interfaces (APIs) that the browser application provides to web pages. The extension application may include hypertext mark-up language (HTML), cascading style sheets (eSS), JavaScript, images, and other types of files and web-related computer languages and code.

In one example implementation, an extension application may use a background element, which is an invisible element that may include the main logic or instructions related to the extension application. In this manner, the background element may function as a central hub for the functionality of the extension application. The background element may be associated with one or more visible elements of the extension application. Upon the launch or a triggering event such as, for example, logging into a computer or logging into the browser application or launching the extension application, the background element launches and begins executing the instructions contained within the background element. In this manner, the extension application provides quick and fast access to content due to the fact that the background element is operating even when the visible elements of the extension are not being displayed. Upon invocation of a visible element of the extension, the background element provides content and information that has been collected in the background.

In another example, an installed application may be an installed web application. A web application may be a normal website that includes extra metadata that is installed as part of the browser application. Installable web apps may use standard web technologies for server-side and client-side code. The extra metadata associated with the installable web application affects the web application's interaction with the browser application. The web application also may be associated with a background element that is an invisible element in the browser application that includes instructions related to one or more visible elements of the web application in the browser application. Upon the triggering of an event such as, for example, launching the browser application or opening the web application, the background element may execute the instructions on its page to perform functions related to the one or more visible elements of the installable web application.

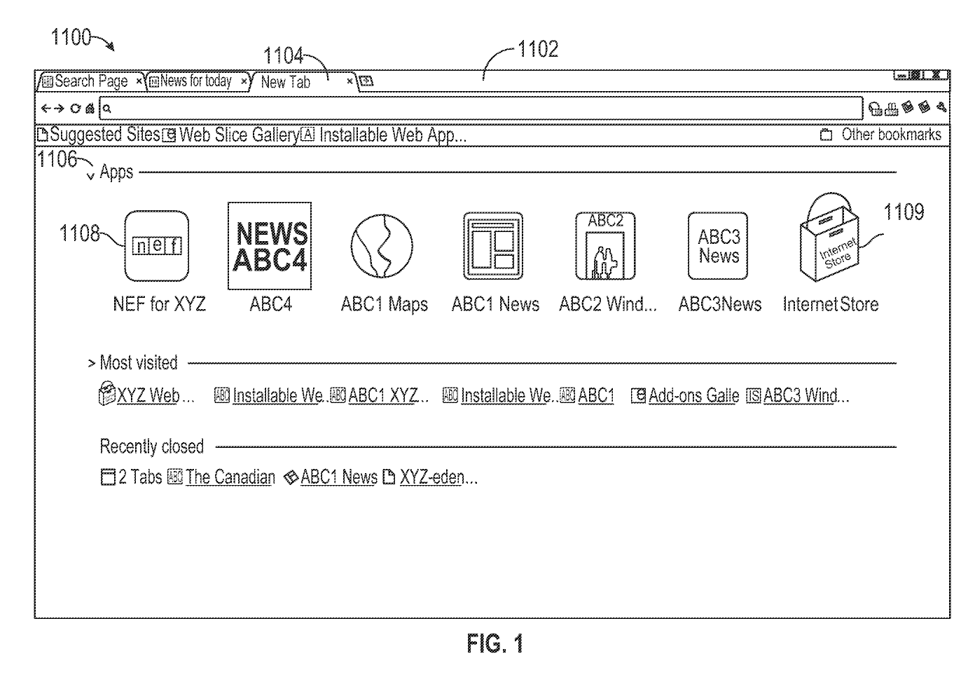

Referring to FIG. 1, an example of a screenshot 1100 is illustrated. The screenshot 1100 illustrates an example of an illustration of a browser application 1102. For example, in one implementation, the browser application 1102 may be the Google Chrome browser application. When a user selects to open a new tab 1104 in the browser application 1102, a user interface 1106 may generate and display the web applications 1108 that are installed in the browser application 1102.

For example, a user may have previously navigated the browser application 1102 to a web store, where the web store is a location on the Internet accessible by the browser application where a user can download applications, such as, web applications and extension applications that are integrated and downloadable as part of the browser application. For instance, the Google Chrome web store is a location on the Internet where users can download such applications and extensions. These installable web applications may be a normal website with some extra metadata. The installable web application and installable web extension applications may be built as a normal web application that uses standard web technologies for both server-side and client-side code. In addition to the normal web application, the installable web applications and extensions may include extra metadata that is associated with the application, which affects the web application's interaction with the browser application.

In this example, the user interface 1106 displays icons for the web applications 1108 that have been installed in the browser application 1102. A selection of one of the icons, for example, by a double-click of an input device or a by a touch on a touch screen interface, causes the installed application to launch, including opening a new tab in the browser application 1102 and directing the new tab to a website associated with the launched application. A selection of the icon 1109 may cause the browser application 1102 to open a new tab and to go to the Internet website for the web store, where a user may browse and install other web applications and extension applications.

In other example implementations, the user interface 1106 may display the installed applications in other ways. For example, the installed applications may be listed by name in a text listing. The installed applications may be grouped or organized in some manner using folders or other hierarchical-type interfaces. Multiple installed applications may extend onto multiple other pages, which may be considered part of the same user interface 1106 that just has extended onto other pages.

From this single user interface 1106, the user may interact with the installed applications 1108 such as, for instance, launching an installed application by selection of its icon. Also, from this single user interface 1106, the user may manage one or more of the functions associated with an installed application.

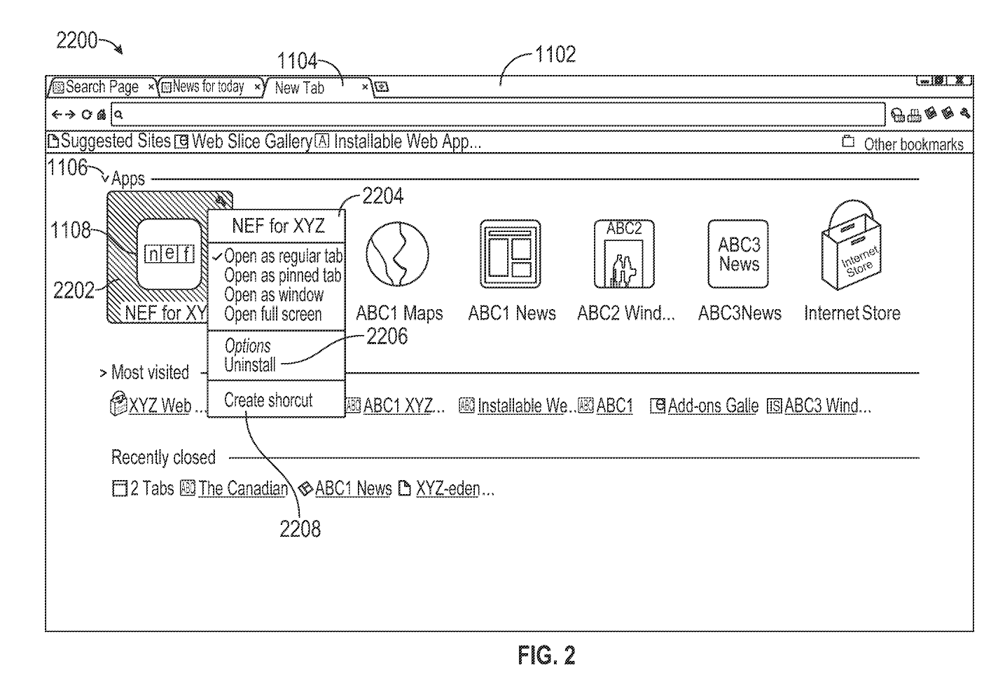

Referring to FIG. 2, an example of a screenshot 2200 of the browser application 1102 is illustrated. In this example, one of the installed applications 1108 has been selected to manage functions and features associated with the installed application. In one example, a tool icon 2202 may be selected and a management window 2204 is generated and displayed. In another example, a user may right-click on the icon using an input device (e.g., a mouse) to generate and display the management window 2204.

The management window 2204 is part of the user interface 1106 that enables control of functions and features related to the installed applications. From the management window 2204, the user may control a launch mode for the web application. For instance, several launch mode options are provided including to open as a regular tab, open as a pinned tab, open as a window or open full screen. A selection of one of these launch modes controls how the application launches each time it is selected to launch. Other types of launch modes may be provided.

In another example implementation, another launch mode may include a panel mode. By selecting the panel mode, the application may be launched in a small pop-up panel. In other example implementations, other features related to the launch mode or related to the appearance and/or behavior of other features may be controlled by the user through the user interface 1106. For example, the behavior and/or appearance of the tab may be controlled as it relates to the launch of a specific application including features such as a larger icon, different tab placement, and different grouping behavior. The behavior and/or appearance of the window may be controlled as it relates to the launch of a specific application including removing the browser chrome and treating the application like a top-level application rather than a sub-window of the browser application. In other implementations, a launch mode may include launching the application as an invisible background service.

The launch modes may operate in a manner that is independent of any installed operating system. The browser application 1102 may be configured to operate with different types of operating systems and functionality of applications installed in the browser application 1102 and may perform in a manner independent of the operating system.

The management window 2204 also enables a user to uninstall 2206 an installed application. If a user selects uninstall 2206, then the installed application will be uninstalled from the browser application 1102. To reinstall an uninstalled application, the user may navigate to the web store and select the application to be installed again in the browser application. In other implementations, the user may navigate to other application hosting providers or directly to a website for the application itself to download and install the application.

The management window 2204 also enables a user to create a new operating system-specific application specific shortcut 2208 (e.g., on the Windows desktop or the OS X dock) for the installed application. If the user selects shortcut 2208, then a new shortcut is generated.

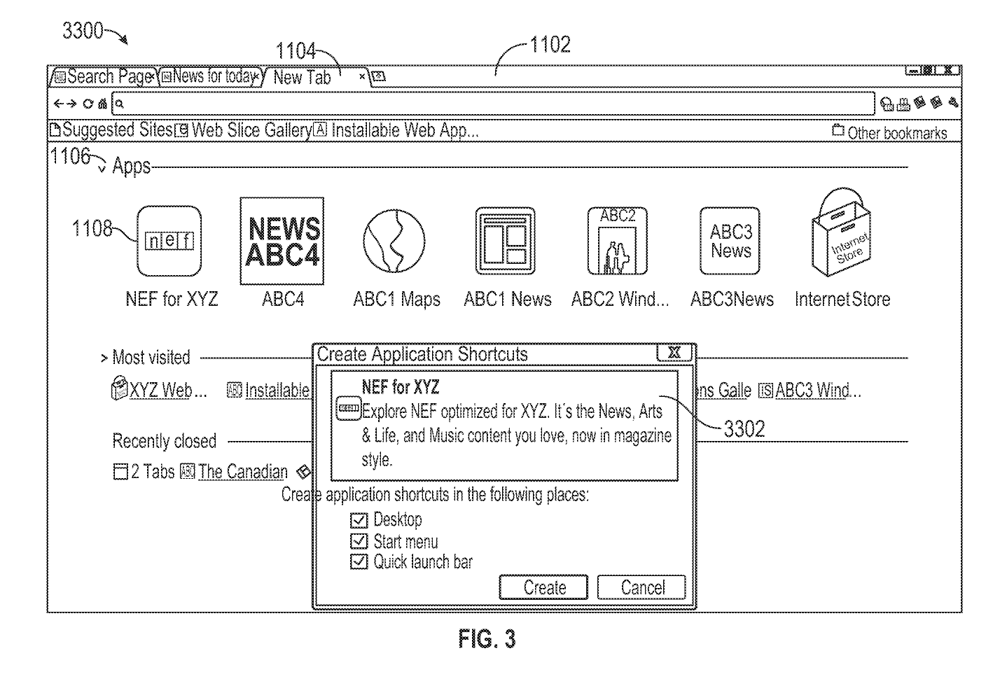

Referring to FIG. 3, an example of a screen shot 3300 illustrates the browser application 1102. In this example, the user's selection of shortcut (shortcut 2208 of FIG. 2) generates and displays a shortcut window 3302 in the single user interface 1106 in the browser application 1102. The shortcut window 3302 provides a point of enabling integration with the installed operating system by allowing options to create a shortcut in one or more locations controlled by the operating system. Shortcuts may be created on the desktop, in the start menu and/or in the quick launch bar. A selection of one or more of the check boxes causes a shortcut to be installed in the selected location. A selection of the shortcut from one of these locations launches the installed application and browser application, if the browser application is not already running.

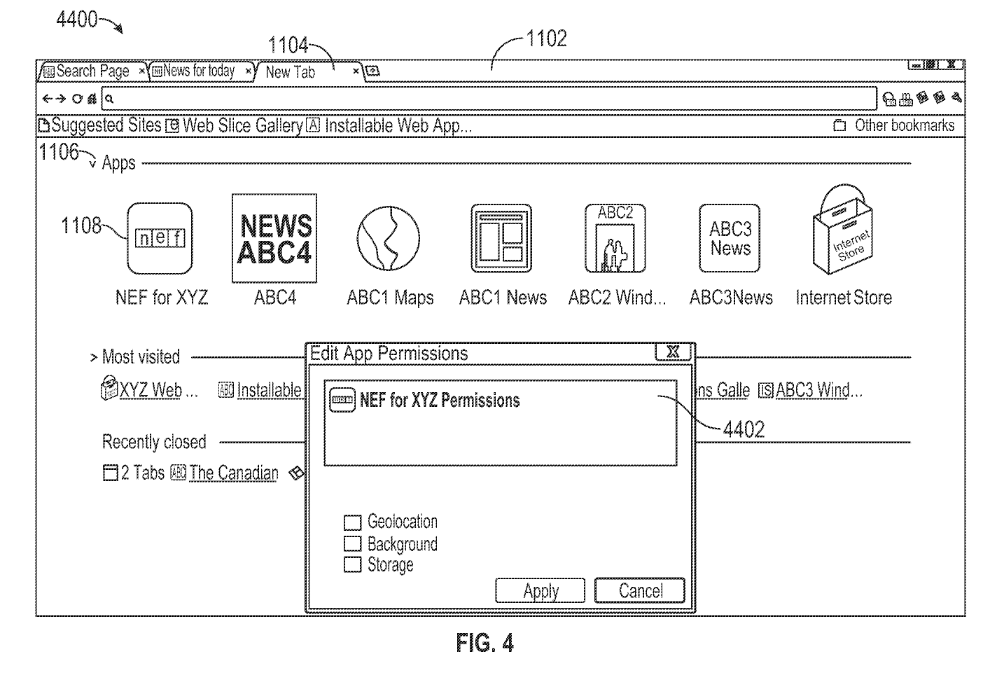

In another example implementation, the user interface 1106 in the browser application 1102 may provide an interface for the user to manage permissions associated with an installed application. Referring to FIG. 4, an example of a screenshot 4400 illustrates the browser application 1102 with a permissions window 4402. The permissions window 4402 may be opened using the user interface 1106 and selecting one of the installed applications 1108, as discussed above. The permissions window 4402 provides an interface within the single user interface 1102 to enable the user to control and manage the permissions associated with an installed application.

The permissions may be a declaration of the access that is desired by the web application or extension application to device-side information, client-related information and/or server-side information associated with the client or device. One or more permissions may be declared and granted by the user as part of the installation process for the application. In this manner, developers of web applications and extension applications declare the desired permissions and associate the declared permissions as part of the application. This informs the user as to the access that is potentially being requested to specific information during the lifetime of the application while in use in the browser application.

The permissions window 4402 allows the user to control the declared permissions associated with an installed application. Turning off one or more of the declared permissions may reduce and limit the performance of the installed application.

In another example implementation, the permissions window 4402 allows the user to control opt-in permissions and the declared permissions. Opt-in permissions may be made optional to the user whereby opting in by the user grants the application one or more other permissions. In other example implementations, the permissions window 4402 allows the user to control only opt-in permissions and not any declared permissions.

While the examples discussed above illustrate and describe the control and management of installed applications on an individual application basis, other example implementations may provide an interface through the single user interface 1106 of the browser application 1102 to enable control of one or more features across multiple installed applications. For example, an interface for permissions related to multiple installed applications may allow a user to control a specific permission or permission type for all of the installed applications. In this manner, for instance, the user may control a geolocation permission or a background permission in a more global or universal manner across multiple installed applications. Other features including the launch mode, uninstallation feature and shortcuts may be controlled in a similar universal manner across multiple installed applications. For instance, an interface may enable the user to designate multiple or all of the installed application to launch in full screen launch mode.

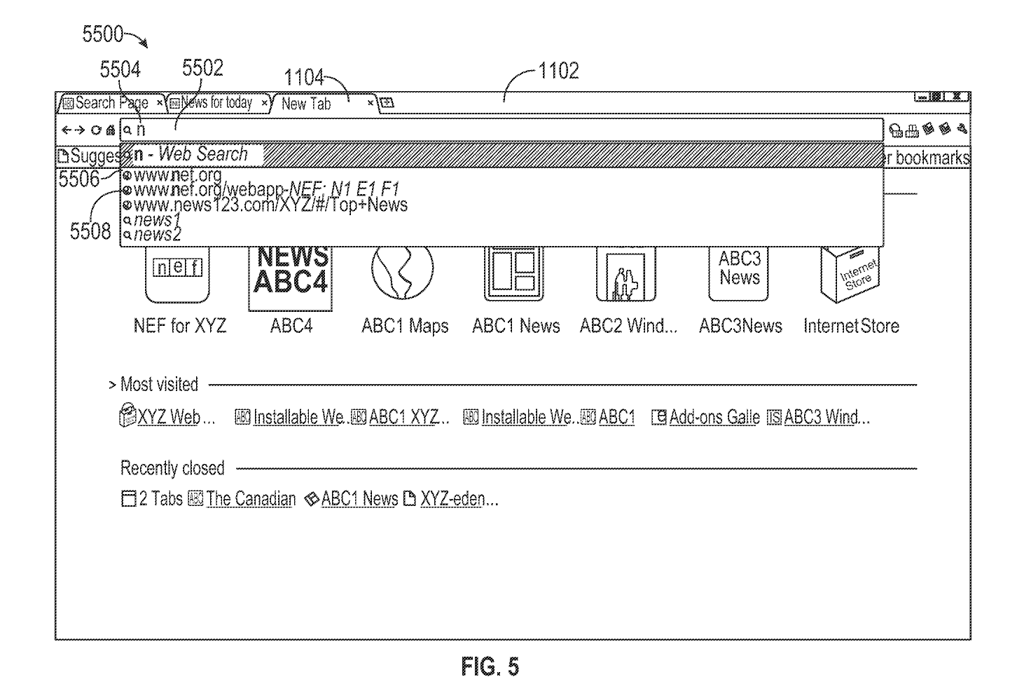

The user interface 1106 also may provide a search interface to search for and launch an installed application. Referring to FIG. 5, an example of a screen shot 5500 illustrates the browser application 1102 and a search window 5502. In one example implementation, the search window 5502 may be referred to as an omnibox search window because it searches for information from multiple, different providers using a single search interface. For example, the search window 5502 may enable a user to enter a query or a partial query and results may be retrieved from multiple sources including, for instance, a search provider, a browser history, a desktop provider and installed application in the browser application. The search query or partial search query may begin to provide results as soon as the first character is entered in the search window 5502.

For the installed applications, the characters entered into the search window 5502 may be compared against the title of the installed application using a string match comparison. In FIG. 5, a user has entered the character “n” 5504 in the search window 5502. A search result window 5506 displays a list of results. The search result window 5506 includes an installed application 5508 in the list of results. A selection of the installed application 5508 from the search result window 5506 may cause the application to launch.

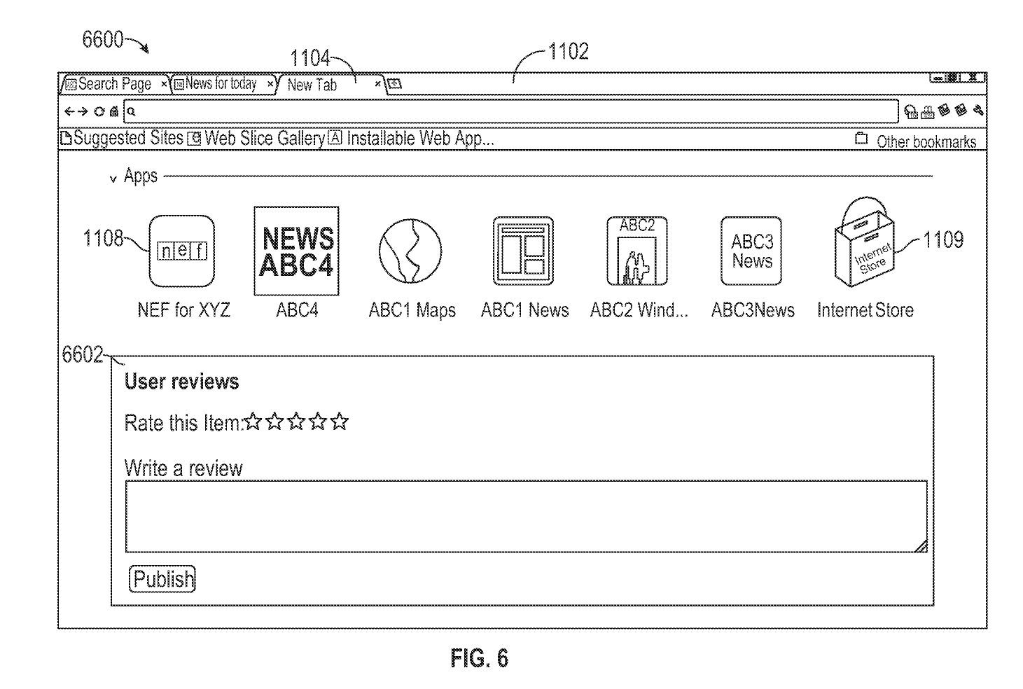

Referring to FIG. 6, an example of a screen shot 6600 illustrates the browser application 1102 and a review window 6602. From the single user interface 1106 in the browser application 1102, a user can rate and write a review for an installed application 1108 using the review window 6602. The review window 6602 may be opened using the user interface 1106 and selecting one of the installed applications 1108, as discussed above. In this manner, the user can rate and review installed applications from this user interface instead of just at the web store website.

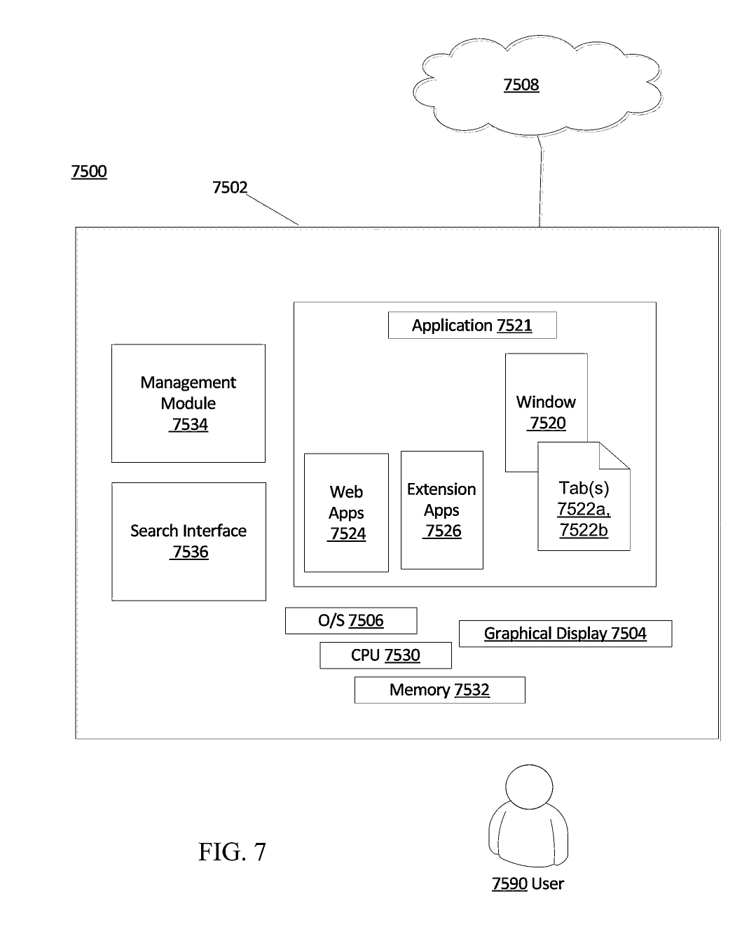

FIG. 7 is a block diagram of an example embodiment of a system 7500 in accordance with the disclosed subject matter. In various implementations, the system 7500 may include a client computer or other computing device (e.g., smart-phone, tablet computer, laptop, etc.) 7502 that executes an operating system 7506, and an application 7521 or window 7520. In one embodiment, the computer may include or be connected to a graphical display 7504 (e.g., a monitor, touch-screen, etc.) and receive input, at least in part, from a user 7590 interacting with the device 7502.

In one example implementation, the device 7502 may be running or causing the operating system 7506 to execute the application 7521 or the window 7520. For purposes of illustration, the application 7521 may be a browser application that includes at least one window 7520. In various implementations, this window 7520 may include multiple panes or tabs 7522a, 7522b. The device 7502 may receive online content from one or more remote server computing devices (not shown) that may be connected to the client device 7502 though a network 7508 such as, for example, the Internet. The online content can be processed and displayed on the graphical display 7504 on a tab 7522a or 7522b in the browser application 7521. In one example implementation, the window 7520 may include a user interface (e.g., user interface 1106 from FIG. 1) to interact with the installed applications.

The user 7590 may navigate to a web store on the Internet and download one or more web applications 7524 and/or extension applications 7526 to install in the browser application 7521. Prior to the installation of a web application 7524 or an extension application 7526, the browser application 7521 presents a notification that includes a request to confirm the installation of the application and that includes a listing of any permissions that are declared by the application. Upon receiving confirmation of the installation, the application is installed and the permissions are granted.

A memory 7532, or other non-transitory computer-readable storage medium, may store instructions and code that are executed by at least one processor 7530. The instructions may include any instructions or code related to the browser application 7521 and the process of installing applications in the browser application, including the notification and granting of permissions associated with the applications. The processor 7530 may execute any code or instructions provided on any background element associated with a web application and/or an extension application.

The browser application also may include a management module 7534. In one example implementation, the management module 7534 is associated with and part of the code associated with the browser application 7521. In other example implementations, the management module 7534 may be a separate component that interacts with the browser application 7521.

The management module 7534 may be configured to cause the at least one processor 7530 to generate and display a management window (e.g., management window 2204 of FIG. 2) to enable a user to interact with and control one or more of the features of an installed application. The management module 7534 enables a user to manage the features of an installed application including the launch mode, the uninstall feature, the permissions feature, the rating and review feature and the shortcut feature.

In one example implementation, the management module 7534 interacts with the operating system 7506 to install a shortcut for the installed application in a location controlled by the operating system 7506. The locations may include the desktop, the start menu and/or the quick launch bar.

The browser application also may include a search module 7536. The search module 7536 may be configured to provide a search window (e.g., search window 5502 of FIG. 5) to enable a user to enter a search string and to display results in a search results window (e.g., search results window 5506 of FIG. 5). The search module 7536 may be configured to interface with multiple providers, where the providers may include an Internet search provider, a browser history module and the list of installed applications in the browser application.

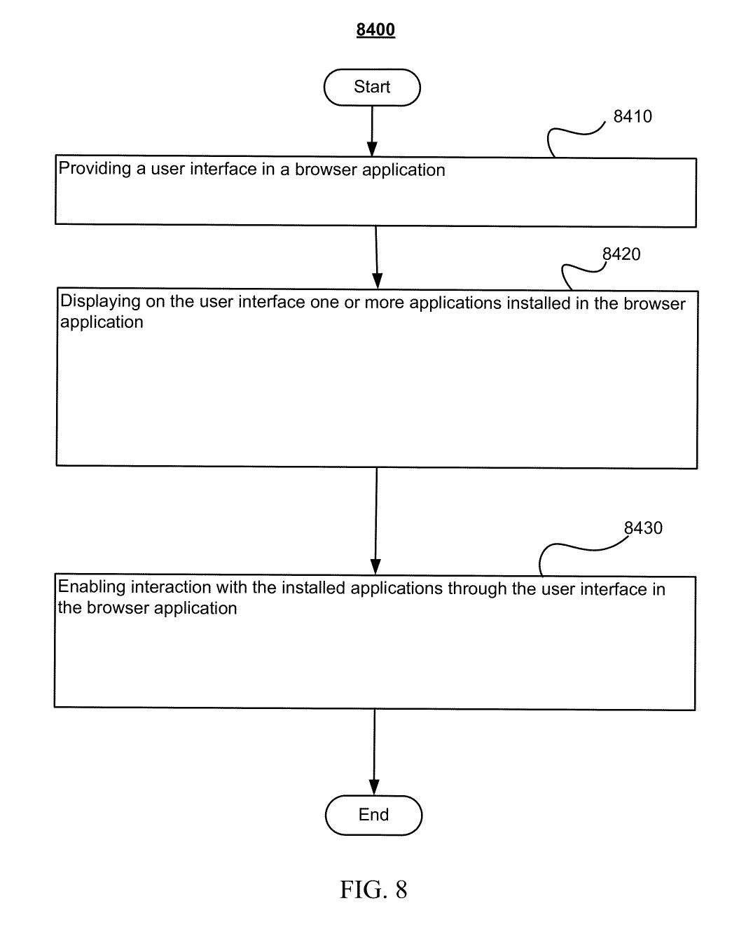

Referring to FIG. 8, an example of a process 8400 illustrates techniques related to the system of FIG. 7. Process 8400 includes providing a user interface in a browser application (8410). For example, a user interface 1106 may be provided in the browser application 1102, as discussed in detail above. One or more applications installed in the browser application may be displayed on the user interface (8420). For example, the web application 1108 is displayed on the user interface 1106 in the browser application 1102.

Process 8400 includes enabling interaction with the installed applications through the user interface in the browser application (8430). For example, the user interface 1106 provides an interaction area in the browser application 1102 to interact with the installed applications 1108. In this manner, an installed application may be launched from the user interface 1106 in the browser application 1102.

As discussed above in detail, the user interface 1106 enables control of one or more features of the installed applications in the browser application. For example, through the user interface 1106, a user may control the launch mode for each installed application and declared permissions for each installed application. Also, a user may use the user interface to uninstall one of the installed applications and to create one or more shortcuts for each of the installed applications.

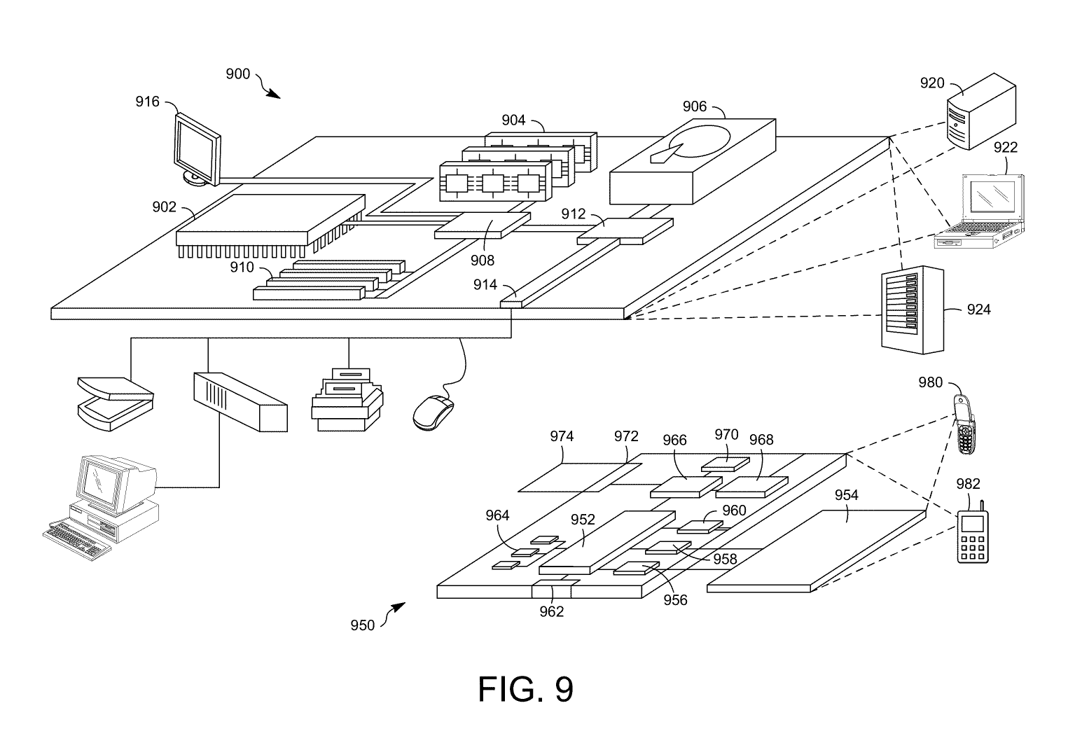

FIG. 9 shows an example of a generic computer device 900 and a generic mobile computer device 950, which may be used with the techniques described herein. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the subject technology described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a micro drive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

According to various aspects of the subject technology, systems and methods are provided for enabling access to web applications. A web application may allow a user to create a profile to log in to the web application in order to use the web application under that specific profile. For example, the web application may comprise a website providing email service, which may allow a user to create a specific email address to send emails from or receive emails at the specific email address. An access point, such as a bookmark, can be used to direct the user to the web application. However, the bookmark typically only directs the user to the web application, and fails to provide the user access to the web application under the user's specific profile (e.g., the specific email address associated with the user).

According to various aspects of the subject technology, an access point can be generated to provide a user access to the web application under a specific profile. For example, the access point may comprise at least one of an icon, a shortcut, a bookmark, and some other suitable link that may be placed within an operating system and/or a browser application. When the user performs an action on the access point, such as by clicking on the access point, the user is able to access the web application automatically as though the user were logged in to the web application under the specific profile. This provides the user with quick access to the web application.

In some aspects, it may be desirable for a user to have multiple profiles associated with a web application. For example, a user may have a first profile for an email website that is associated with personal use. The user may also have a second profile for the same email website that is associated with work use. According to certain aspects, multiple access points may be generated to access the same web application, wherein each of the multiple access points is associated with a different profile of the user. In some aspects, these multiple access points may allow a user to access the same web application under different profiles at the same time.

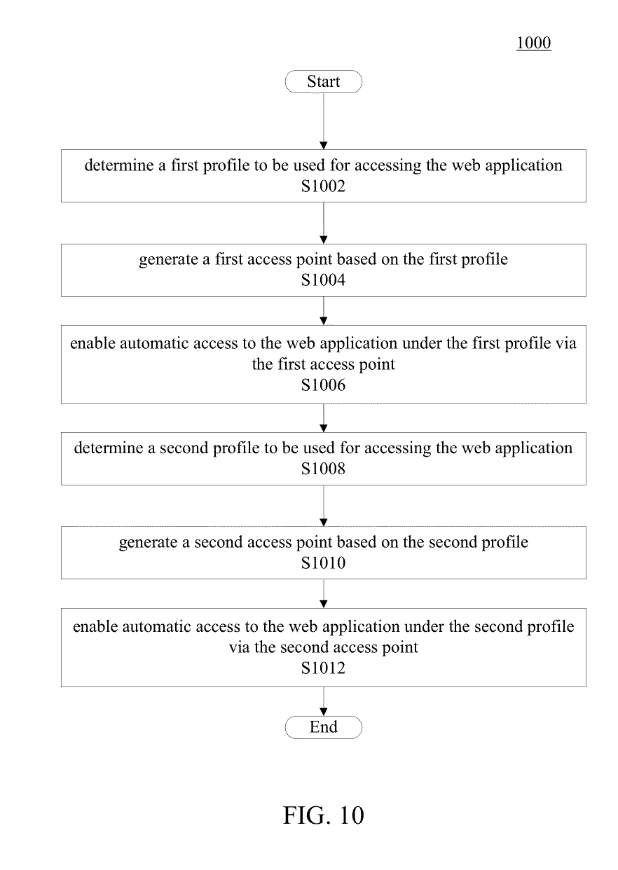

FIG. 10 illustrates an example of a method 1000 for enabling access to a web application, in accordance with various aspects of the subject technology. The method 1000, for example, may be used to generate access points that enable a user to access the web application under a specific profile. In some aspects, the method 1000 may be implemented by the system 7500 in FIG. 7. However, the method 1000 may be implemented by other suitable systems having different configurations from system 7500.

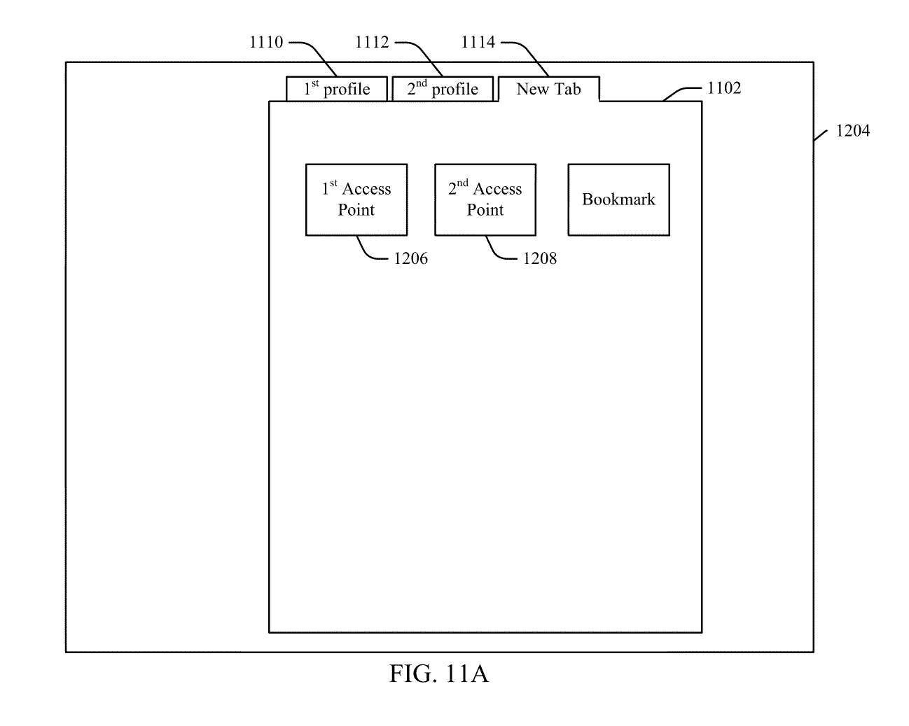

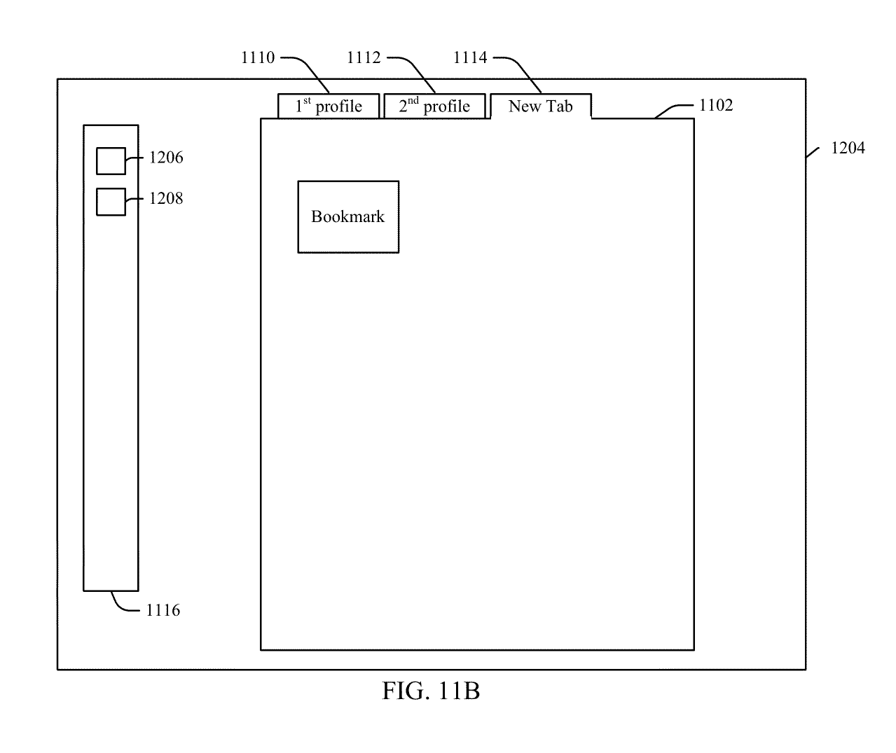

FIG. 11A illustrates an example of a browser application 1102 of an operating system 1204 that may be used to access the web application, in accordance with various aspects of subject technology. As shown in FIG. 11A, a window 1110, which in this example is a tab of the browser application 1102, may be used to display the web application under a first profile. The first profile may be associated with first identity information of a first user. This first identity information may comprise at least one of first login data, first password data, first cookie data, and other suitable information for identifying the first profile of the first user and/or for helping the first user log in to the web application under the first profile. The method 1000, for example, may be used to generate a first access point 1206 that can provide access to the web application under the first profile.

According to certain aspects, the management module 7534 may use the first profile for generating the first access point 1206. Referring to FIGS. 7, 10, and 11A, according to step S 1002, the management module 7534 may determine the first profile to be used for accessing the web application. For example, the management module 7534 may determine if the first user is currently logged in to the web application under the first profile (e.g., window 1110 is currently open and is configured to display the web application under the first profile). If so, the management module 7534 may be able to identify the currently logged in profile as the first profile to be used for generating the first access point 1206. In some aspects, the management module 7534 may identify the first profile as the profile to be used for generating the first access point 1206 based on how frequently the first profile is used to access the web application. For example, if the first profile is frequently used to access the web application, the management module 7534 may determine the first profile as the profile to be used for generating the first access point 1206.

In some aspects, the management module 7534 may identify the first profile based on user input. For example, the management module 7534 may receive the first identity information from the first user using various means, such as by having the first user enter the first identity information to access the web application. The first identity information may be used to generate the first access point 1206 and/or access the web application under the first profile. For example, the first access point 1206 may refer to the first identity information as well as the location of the web application (e.g., uniform resource locator of the web application). Thus, if the first user performs an action on the first access point 1206 (e.g., clicking on the first access point 1206), the first user may not only be directed to the web application (using the location of the web application referenced by the first access point 1206), but may also be logged in to the web application under the first profile (using the first identity information referenced by the first access point 1206).

In some aspects, the management module 7534 may store the first identity information into memory (e.g., memory 7532, 904, and/or 964) so that this information may be retrieved later to generate the first access point 1206 and/or access the web application under the first profile. In some aspects, the first identity information may be stored such that it is shared with other different web applications, which may be useful, for example, if the first user used the same information (e.g., login data, password data, cookie data, etc.) for the different web applications. Thus, access points corresponding to the other different web applications may be generated, and these access points may refer to the same first identity information. In some aspects, the first identity information may be stored in isolation for the first access point 1206 (e.g., an independent storage location for the first access point 1206). Thus, compared to other access points, only the first access point 1206 may have access to the first identity information.

According to step S 1004, the management module 7534 may generate the first access point 1206 based on the first profile (e.g., determined from step S 1002). For example, the first access point 1206 may comprise at least one of an icon, a shortcut, a bookmark, and some other suitable link that provides access to the web application under the first profile.

According to step S 1006, the management module 7534 may enable automatic access to the web application under the first profile via the first access point 1206. For example, the management module 7534 may provide for display the first access point 1206. As shown in FIG. 11A, the first access point 1206 is displayed in a window 1114, which is a new tab of the browser application 1102. The management module 7534 may enable user interaction with the first access point 1206. For example, the first user may click on the first access point 1206 or perform some other suitable action on the first access point 1206. Based on this user interaction, the management module 7534 may provide access to the web application under the first profile. For example, the management module 7534 may provide access to the web application under the first profile in response to the first user clicking on the first access point 1206 (or performing some other suitable action on the first access point 1206).

In some aspects, the management module 7534 may provide access to the web application either by using a previously opened window or a new window to display the web application under the first profile. For example, the management module 7534 may determine if a previous window configured to display the web application under the first profile is open, and may render this window active if it is open. As shown in FIG. 11A, window 1110, which contains contents of the web application under the first profile, is already open. Thus, if the user selects the first access point 1206, the management module 7534 may make this window active (e.g., by making the contents of the web application contained therein visible to the user). By using the previously opened window to display the web application under the first profile, multiple windows displaying the same web application under the first profile can be avoided.

In some aspects, if the previous window is not open, then the management module 7534 may automatically attempt to access the web application (e.g., automatically logging in to the web application under the first profile). For example, the management module 7534 may provide the first identity information (referenced by the first access point 1206) to the web application (at the location referenced by the first access point 1206) in order to log the first user in to the web application. In response to this action, the management module 7534 may receive authorization to access the web application under the first profile. The management module 7534 may then use a new window (e.g., window 1114) to display the web application under the first profile if the authorization is received.

As discussed above, multiple access points may be generated to access the same web application, wherein each of the multiple access points is associated with a different profile. According to step S 1008, the management module 7534 may determine a second profile to be used for accessing the web application. The second profile may be different from the first profile, and may be used to generate a second access point 1208 that provides access to the web application under the second profile. The second profile may be associated with second identity information of a second user. The second identity information may comprise at least one of second login data, second password data, second cookie data, and other suitable information for identifying the second profile of the second user and/or for helping the second user log in to the web application under the second profile.

In some aspects, the second user may be different from the first user. For example, the first user and the second user may share the use of the operating system 1204 and/or browser application 1102. Thus, the first access point 1206 may be used by the first user to access the web application under the first profile, while the second access point 1208 may be used by the second user to access the web application under the second profile.

In some aspects, the second user may be the same user as the first user, except that the second profile is different from the first profile. For example, as discussed above, a user may have a first profile for an email website that is associated with personal use. The same user may also have a second profile for the same email website that is associated with work use. Thus, according to certain aspects, the first user and the second user may be considered the same user, but with different profiles.

The second profile may be used to generate the second access point 1208. According to certain aspects, the management module 7534 may identify the second profile as the profile to be used for generating the second access point 1208 based on how frequently the second profile is used to access the web application. For example, if the second profile is not as frequently used as the first profile to access the web application, the management module 7534 may determine the second profile as the profile to be used for generating the second access point 1208.

In some aspects, the management module 7534 may identify the second profile based on user input. For example, the management module 7534 may receive the second identity information from the second user using various means, such as by having the second user enter the second identity information to access the web application. The second identity information may be used to generate the second access point 1208 and/or access the web application under the second profile. For example, the second access point 1208 may refer to the second identity information as well as the location of the web application (e.g., uniform resource locator of the web application). Thus, if the second user performs an action on the second access point 1208 (e.g., clicking on the second access point 1208), the second user may not only be directed to the web application (using the location of the web application referenced by the second access point 1208), but may also be logged in to the web application under the second profile (using the second identity information referenced by the second access point 1208).

In some aspects, the management module 7534 may store the second identity information into memory (e.g., memory 7532, 904, and/or 964) so that this information may be retrieved later to generate the second access point 1208 and/or access the web application under the second profile. In some aspects, the second identity information may be stored such that it is shared with other different web applications, which may be useful, for example, if the second user used the same information (e.g., login data, password data, cookie data, etc.) for the different web applications. Thus, access points corresponding to the other different web applications may be generated, and these access points may refer to the same second identity information. In some aspects, the second identity information may be stored in isolation for the second access point 1208 (e.g., an independent storage location for the second access point 1208). Thus, compared to other access points, only the second access point 1208 may have access to the second identity information. In some aspects, the second identity information may be stored separately from the first identity information so that accessing the web application under the second profile (using the second access point 1208) may be separate from accessing the web application under the first profile (using the first access point 1206).

According to step S 1010, the management module 7534 may generate the second access point 1208 based on the second profile. For example, the second access point 1208 may comprise at least one of an icon, a shortcut, a bookmark, and some other suitable link that provides access to the web application under the second profile. In some aspects, a user interface (e.g., user interface 1106) is provided that allows the second user to generate the second access point 1208. For example, the user interface may allow the second user to right-click on the first access point 1206 using an input device (e.g., a mouse) to generate and display a management window (similar to management window 2204 in FIG. 2). This management window may enable control of functions and features related to the generation of the second access point 1208. For example, from this management window, the second user may select an option to generate the second access point 1208. Upon selecting this option, the management module 7534 may generate the second access point 1208 using the stored second identity information. If the second identity information was not previously stored, then the second user may be prompted to enter the second identity information. In some aspects, the management window may provide other options for the second user, such as selecting a specific appearance of the second access point 1208.

In some aspects, the second access point 1208 may be visually different from the first access point 1206. For example, the second access point 1208 may have a color, shape, shading, badge overlay, or other visual feature that is different from the first access point 1206. This difference may allow a user to distinguish the first access point 1206 from the second access point 1208.

According to step S 1012, the management module 7534 may enable automatic access to the web application under the second profile via the second access point 1208. For example, the management module 7534 may provide for display the second access point 1208. As shown in FIG. 11A, the second access point 1208 is displayed in window 1114. The management module 7534 may enable user interaction with the second access point 1208. For example, the second user may click on the second access point 1208 or perform some other suitable action on the second access point 1208. Based on this user interaction, the management module 7534 may provide access to the web application under the second profile in response to the second user clicking on the second access point 1208 (or performing some other suitable action on the second access point 1208).

In some aspects, the management module 7534 may provide access to the web application either by using a previously opened window or a new window to display the web application under the second profile. For example, the management module 7534 may determine if a previous window configured to display the web application under the second profile is open, and may render this window active if it is open. As shown in FIG. 11A, window 1112, which is a tab that contains contents of the web application under the second profile, is already open. Thus, if the user selects the second access point 1208, the management module 7534 may make this window active (e.g., by making the contents of the web application contained therein visible to the user). By using the previously opened window to display the web application under the second profile, multiple windows displaying the same web application under the second profile can be avoided.

In some aspects, if the previous window is not open, then the management module 7534 may automatically attempt to access the web application (e.g., automatically logging in to the web application under the second profile). For example, the management module 7534 may provide the second identity information (referenced by the second access point 1208) to the web application (at the location referenced by the second access point 1208) in order to log the second user in to the web application. In response to this action, the management module 7534 may receive authorization to access the web application under the second profile. The management module 7534 may then use a new window (e.g., window 1114) to display the web application under the second profile if the authorization is received. According to certain aspects, the automatic access to the web application under the first profile and the automatic access to the web application under the second profile may be enabled at the same time, thereby allowing a user to simultaneously access the same web application using different profiles.

Although the first access point 1206 and the second access point 1208 are shown as being a part of browser application 1102 in FIG. 11A, the first access point 1206 and the second access point 1208 may also generally be part of the operating system 1204. For example, FIG. 11B illustrates an example of the first access point 1206 and the second access point 1208 as generally part of the operating system 1204, in accordance with various aspects of the subject technology. As shown in FIG. 11B, the first access point 1206 and the second access point 1208 are displayed in a desktop area of the operating system 1204. In particular, the first access point 1206 and the second access point 1208 are displayed as part of a taskbar 1116 of the operating system 1204. However, the first access point 1206 and the second access point 1208 may be displayed at any suitable part of the operating system 1204 (e.g., the start menu and/or the quick launch bar) as long as a user may be able to select these access points to access the web application under a corresponding profile. In some aspects, once the user performs an action on either the first access point 1206 or the second access point 1208, browser application 1102 may be opened in order provide the user access to the web application under the first profile or the second profile depending on which access point was selected by the user. Although only two access points are described, aspects of the subject technology may include generating and/or using more than two access points for accessing the web application, wherein a different profile is associated with each of the access points.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology.

1. A computer-implemented method comprising:
determining a first profile to be used for accessing a web application installed in a browser application;
generating a first access point based on the first profile;
enabling automatic access to the web application under the first profile via the first access point;
determining a second profile to be used for accessing the web application, the second profile being different from the first profile;
generating a second access point based on the second profile, the second access point being different from the first access point; and
enabling automatic access to the web application under the second profile via the second access point.

2. The method of claim 1, wherein the first profile is associated with first identity information of a first user, and wherein the second profile is associated with second identity information of a second user.

3. The method of claim 2, wherein the first user is different from the second user.

4. The method of claim 2, wherein the first identity information comprises at least one of first login data, first password data, and first cookie data, and wherein the second identity information comprises at least one of second login data, second password data, and second cookie data.

5. The method of claim 2, wherein determining the first profile comprises receiving the first identity information from the first user, and wherein determining the second profile comprises receiving the second identity information from the second user.

6. The method of claim 2, wherein determining the first profile comprises storing the first identity information, and wherein determining the second profile comprises storing the second identity information.

7. The method of claim 6, wherein the first identity information is stored separately from the second identity information.

8. The method of claim 6, wherein the first identity information is stored in isolation for the first access point, and wherein the second identity information is stored in isolation for the second access point.

9. The method of claim 1, wherein the first access point comprises at least one of an icon, a shortcut, and a bookmark, and wherein the second access point comprises at least one of an icon, a shortcut, and a bookmark.

10. The method of claim 1, wherein the first access point is visually different from the second access point.

11. The method of claim 1, wherein enabling automatic access to the web application under the first profile comprises:
providing for display the first access point;
enabling user interaction with the first access point; and
providing access to the web application under the first profile based on the user interaction.

12. The method of claim 11, wherein enabling automatic access to the web application under the second profile comprises:
providing for display the second access point;
enabling user interaction with the second access point; and
providing access to the web application under the second profile based on the user interaction with the second access point.

13. The method of claim 11, wherein providing access to the web application under the first profile comprises:
determining if a previous window configured to display the web application under the first profile is open;
rendering the previous window active if the previous window is open;
providing first identity information associated with the first profile to the web application if the previous window is not open;
receiving authorization to access the web application under the first profile in response to providing the first identity information; and
using a new window to display the web application under the first profile based on the authorization.

14. The method of claim 12, wherein providing access to the web application under the second profile comprises:
determining if a previous window configured to display the web application under the second profile is open;
rendering the previous window active if the previous window is open;
providing second identity information associated with the second profile to the web application if the previous window is not open;
receiving authorization to access the web application under the second profile in response to providing the second identity information; and
using a new window to display the web application under the second profile based on the authorization.

15. The method of claim 1, wherein the automatic access to the web application under the first profile and the automatic access to the web application under the second profile are enabled at the same time.

16. (canceled)

17. A system comprising:
one or more processors; and
a non-transitory machine-readable medium comprising instructions stored therein, which when executed by the processors, cause the processors to perform operations comprising:
determining a first profile to be used for accessing a web application installed in a browser application;
generating a first access point based on the first profile;
enabling automatic access to the web application under the first profile via the first access point;
determining a second profile to be used for accessing the web application; generating a second access point based on the second profile, the second access point being different from the first access point; and
enabling automatic access to the web application under the second profile via the second access point, wherein the second profile is different from the first profile.

18. The system of claim 17, wherein the operations further comprise: providing for display the first access point to enable user interaction with the first access point, and to provide access to the web application under the first profile based on the user interaction.

19. The system of claim 18, wherein the operations further comprise: determining if a previous window configured to display the web application under the first profile is open; rendering the previous window active if the previous window is open; providing first identity information associated with the first profile to the web application if the previous window is not open; receiving authorization to access the web application under the first profile in response to providing the first identity information; and using a new window to display the web application under the first profile based on the authorization.

20. A non-transitory computer-readable medium encoded with executable instructions, the instructions comprising code for:
determining a first profile to be used for accessing a web application installed in a browser application;
generating a first access point based on the first profile;
enabling automatic access to the web application under the first profile via the first access point;
determining a second profile to be used for accessing the web application, the second profile being different from the first profile;
generating a second access point based on the second profile, the second access point being different from the first access point; and
enabling automatic access to the web application under the second profile via the second access point,
wherein the automatic access to the web application under the first profile and the automatic access to the web application under the second profile are enabled at the same time.

21. The non-transitory computer-readable medium of claim 20, wherein enabling automatic access to the web application under the first profile comprises:
providing for display the first access point;
enabling user interaction with the first access point; and
providing access to the web application under the first profile based on the user interaction.

22. The non-transitory computer-readable medium of claim 21, wherein providing access to the web application under the first profile comprises:
determining if a previous window configured to display the web application under the first profile is open;
rendering the previous window active if the previous window is open;
providing first identity information associated with the first profile to the web application if the previous window is not open;
receiving authorization to access the web application under the first profile in response to providing the first identity information; and
using a new window to display the web application under the first profile based on the authorization.
